(19) United States
(12) Patent Application Publication
(10) Pub. No.: US 2015/0088323 A1
(43) Pub. Date: Mar. 26, 2015

(54) INTERFACE ACCESSORY FOR A RETICULATION CONTROLLER

(71) Applicant: Bookleaf Pty Ltd, Perth (AU)

(72) Inventors: Walter John Edwards, Perth (AU); Michael Barrington Wood, Perth (AU)

(21) Appl. No.: 14/496,958

(22) Filed: Sep. 25, 2014

(30) Foreign Application Priority Data
Sep. 26, 2013 (AU) 2013903728

(51) Int. Cl. A01G 25/16; G05B 15/02

(52) U.S. Cl. CPC A01G 25/16; G05B 15/02
USPC 700/284

(57) ABSTRACT

An interface system 11 for an irrigation controller arranged to operate a plurality of electrically operated valves 21 over at least two wires is disclosed. The system includes a valve interface unit 27 having outputs 29, each for connection to a valve, and input 33 and common 35 connectors to connect to a feed wire 23 and a return wire remotely from the irrigation controller. The system has a user programmable input 49, 51, 53, 55 interfaced within a controller 41 to set the allocation time for power to provided sequentially to the outputs 29 to power the valves.

### TECHNICAL FIELD

This invention relates to the field of reticulation, irrigation or garden watering. In particular this invention provides an accessory to expand the operational functionality of an irrigation controller.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

Reticulation or irrigation systems comprising an irrigation controller connected with electrically operated valves (usually electrically operated solenoid valves) are known and used for domestic gardens and parks in towns and cities located in semiarid and arid locations, where there is not a reliable rainfall. These systems take the guesswork out of hand-watering or manual watering, and by controlling the run times for watering different zones, can result in a saving of water, compared with manual watering and in particular compared with manually moving a sprinkler connected to a hose, around a garden.

When such reticulation or irrigation systems are installed, they are usually installed without regard to any future expansion; that is to say, only the required number of cables are run in order to connect the valves which operate the watering zones, and no more. These cables are usually run underground, and in due course the ground is landscaped with paving, lawns and gardens, or the existing landscaping is altered over time, and the location where the cabling is buried cannot be easily determined, or it is simply inconvenient to lay further cables.

Watering zones are required on two counts; first that there is not usually sufficient water pressure to water all areas simultaneously, and second that different areas of a garden can have different watering requirements and hence watering times, due to different types of vegetation, for example lawn, vegetable garden, fruit trees, and decorative gardens including arid low water demand plants such as natives and high water demand plants such as ferns. There can be other factors too, such as different flow rate sprinklers and drippers, and some watering zones being located under pergolas as is the case with drip irrigating pat plants.

Throughout the specification unless the context requires otherwise, the word “comprise” or variations such as “comprises” or “comprising”, will be understood to imply the inclusion of a stated integer or group of integers but not the exclusion of any other integer or group of integers.

This invention seeks to provide an accessory which can be used to expand an existing reticulation system to avoid the need to lay additional cables or to replace the existing irrigation controller.

### SUMMARY OF INVENTION

In accordance with one aspect of the present invention there is provided an interface system for an irrigation controller arranged to operate a plurality of electrically operated valves over at least two wires being at least one feed and a return, wherein said interface system includes a valve interface unit having at least one output, each output for connection to an electrically operated valve, and a return/common connection for connection to said electrically operated valves, and an input and common connectors to connect to a feed wire and a return wire remotely from said irrigation controller; said interface system having a user programmable input interfaced with a controller to set the allocation time for power to each of said electrically operated valves sequentially, while power is provided to the input and common connectors. By setting the allocation time for power to each of said electrically operated valves sequentially”, the intended meaning is that each valve is operated “one at a time”. While it is true that in many arrangements of the invention, each valve will be operated one at a time and one immediately after another, in some arrangements the sequential operation can be interrupted. Similarly if for operational requirements, the user programmable input selects a zero run time for any one said output, that output will in operation, be skipped in the sequence.

In practice, whichever way the run time is configured, the sum of runtimes selected by the user programmable input for all of the electrically operated valves is set by the user to be the same as the programmed run time of the output of the irrigation controller that the input of the interface unit is connected to.

In one preferred embodiment or arrangement the user programmable input and the controller are located in the valve interface unit. However, as will be understood, this is not the only possible arrangement according to the invention.

In a preferred embodiment, for fail safe operation, said valve interface unit includes a circuit to ensure that an output of said at least one output operates if the input is powered. This ensures that if the sum of the runtimes is exceeded due to user error, and the input remains powered, the irrigation controller will not have a pump running against a closed head.

In a preferred embodiment, the valve interface unit derives its power supply from the power supplied via the input and common connectors. In a preferred embodiment, the valve interface unit includes a circuit to supply power to an output of said at least one output while circuitry in said valve interface unit initialises on powering up said input and common connectors. Again, the reason for this is to ensure that the irrigation controller does not operate a pump against a closed head while the valve interface unit initialises. The output powered by the circuitry would ordinarily or ideally be the first output in the sequence, in order to achieve seamless operation in the sequencing of the valves.

Alternatively, or preferably the valve interface unit includes its own power supply, which may include rechargeable batteries which are charged during operation of the valve interface unit. Still further, alternatively the valve interface unit includes its own power supply which is independent of power supplied via the input and common connectors. Other configurations are possible, such as the valve interface circuitry having control electronics powered by a lithium cell (rechargeable or a button cell), while the output power is derived from the power fed by the irrigation controller to the input and common connectors.

In a preferred embodiment, the user programmable input comprises a set of switches through which runtime can be entered for each said output to each said electrically operated valve. The switches may be a keypad connected with a microcontroller having a display so the user can see the runtime entered for the electrically operated valves. Alternatively the switches may be a set of dip switches (dual in-line package of parallel arranged switches). The runtime may be a common run time where each said output to each electrically operated valve operates for the same time as selected, and the outputs sequence one at a time to operate one electrically operated valve after the other.

In practice, whichever way the run time is configured, the sum of runtimes for all of the electrically operated valves is set by the user to be the same as programmed run time of the output of the irrigation controller that the input of the interface unit is connected to. Preferably for fail safe operation, said valve interface unit includes a circuit to ensure that an output operates if the input is powered.

In a preferred embodiment, the user programmable input comprises a set of switches through which runtimes can be entered separately for each said output to each said electrically operated valve. In this manner each electrically operated valve may have a runtime independent of the others.

In a particularly preferred embodiment, the user programmable input comprises a set of 4 way dip switches, being one for each said output, each 4 way dip switch being used to set in binary a runtime variation of from 0 to 16 minutes in one minute intervals. Various other arrangements of DIP switch are feasible, as noted in the following paragraphs describing preferred arrangements.

Preferably the user programmable input comprises a set of 5 way dip switches, being one for each said output, each 5 way dip switch being used to set in binary a runtime variation of from 0 to 32 minutes in one minute intervals.

Preferably the user programmable input comprises a set of 6 way dip switches, being one for each said output, each 6 way dip switch being used to set in binary a runtime variation of from 0 to 64 minutes in one minute intervals.

Preferably the user programmable input comprises a set of 7 way dip switches, being one for each said output, each 7 way dip switch being used to set in binary a runtime variation of from 0 to 128 minutes in one minute intervals.

Preferably the user programmable input comprises a set of 8 way dip switches, being one for each said output, each 8 way dip switch being used to set in binary a runtime variation of from 0 to 256 minutes in one minute intervals.

In all of the above described dip switch arrangements, it can be seen that there is provided a set of dip switches with each dip switch being used to set a run time in one minute intervals. While the interval is set at one minute, other intervals are possible, with the only real limitation being the ability of the user to easily understand the setting that is made.

For proper operation the period that power is provided to operate said electrically operated valves should be the same as the sum of the runtimes of all of said electrically operated valves. This is set by the user programming the irrigation controller with which the system of the invention is used.

In the simplest form of the invention, the user programmable input is co-located with the valve interface unit. The two wires being a feed and a return are connected at one end to a station/zone output and common of an irrigation controller, and the other end to the input and common connectors of the interface unit. The electrically operated valves are electrically connected to outputs of the valve interface unit as are the common/return wires connected to common in the interface unit, and the time for operation of the valves is entered using the user programmable input. At the irrigation controller, the runtime for the station/zone output to which the feed wire is connected is set to the sum of the runtimes of the outputs connected to the electrically operated valves.

The above described arrangement operates a plurality of valves from a single watering zone output of the irrigation controller, in splitter mode, with the dividing of watering times being determined in the valve interface unit.

In accordance with another arrangement of the present invention said interface system includes an irrigation controller interface unit having a plurality of inputs for connection to irrigation controller watering zone outputs and a return/common connector to connect to the irrigation controller common, and an output being for connection to a feed to connect remotely to the input connector of said valve interface unit, where said irrigation controller interface unit includes and encoder to encode data onto wiring connecting the valve interface unit to identify which irrigation controller interface unit input is actuated, and said valve interface unit includes a decoder to decode said data and provide said data to said controller, and said controller on receiving said data operates to switch on the appropriate output of the valve interface unit corresponding with the input of the irrigation controller interface unit that is actuated.

In one preferred version of this arrangement, the controller may include a switch associated therewith to select the controller between operating valves according to the allocation times or according to the decoded data. The switch may be a user operable switch to select the desired mode of operation or may be an internal switch that is operated automatically on detection of data. The irrigation controller interface unit may be arranged to only encode data if more than one input is connected to an irrigation controller output.

Either above described arrangements of the invention allows multiple watering zones to be controlled via a single pair of wires, with the first arrangement allowing a single zone of an irrigation controller to be split or expanded into multiple outputs for connection to multiple electrically operated valves (expander mode), and the second arrangement described immediately above allowing multiple outputs of an irrigation controller to be connected to multiple electrically operated valves over a single pair of wires (splitter mode). With the first arrangement, in one form of the invention only a valve interface unit is required and with the second arrangement both an irrigation controller interface unit and a valve interface unit are required.

In the most preferred arrangement of the invention, the user programmable input for setting the runtimes and the controller, are located in the irrigation controller interface unit. With this arrangement, the controller is interfaced with the encoder to encode data onto wiring connecting said valve interface unit to select the valve to be operated by the valve interface unit.

In a particularly preferred and useful embodiment, the irrigation controller interface unit includes circuitry to detect how many inputs are connected to an irrigation controller, wherein if more than one input is connected, said user programmable input for setting the runtimes and the controller are disabled by said circuitry, and said encoder encodes data onto wiring connecting said valve interface unit to identify which irrigation controller interface unit input is actuated; and if only one input is connected, said user programmable input for setting the runtimes and the controller are enabled by said circuitry, and said encoder encodes data onto wiring connecting said valve interface unit to identify which valve is selected to be operated by said controller (as set by said user programmable input which is interfaced with said controller). This arrangement simplifies setup for the installer. With this arrangement, it can be seen that when more than one input of the irrigation controller interface unit is connected to an irrigation controller, the outputs of the valve interface unit that are actuated will depend on which inputs of the irrigation controller interface unit are actuated by the irrigation controller. While this is usually sequential or one at a time, it will not necessarily be one after the other, since it is dependent solely on the programming and operation of the irrigation controller.

Alternatively, a manually operable switch is provided to allow the user to select between the two modes of operation.

Still further, alternatively a single separate input is provided where if connected, said user programmable input for setting the runtimes and the controller are enabled by said circuitry, and said encoder encodes data onto wiring connecting said valve interface unit to identify which valve is selected to be operated by said controller. Preferably if said single separate input is not connected, said user programmable input for setting the runtimes and the controller are disabled by said circuitry, and said encoder encodes data onto wiring connecting said valve interface unit to identify which irrigation controller interface unit input is actuated.

Preferably if the plurality of inputs are connected, said user programmable input for setting the runtimes and the controller are disabled by said circuitry.

Preferably if the plurality of inputs are connected, said encoder encodes data onto wiring connecting said valve interface unit to identify which valve is selected to be operated by said controller.

It will be appreciated that the manner of determining which arrangement selects the mode of operation of the irrigation controller interface unit may be based on many different measurable parameters.

Preferably data communication between said irrigation controller interface unit and said valve interface unit is two way to enable fault data to be transmitted back to said irrigation controller interface unit.

Preferably said irrigation controller interface unit includes a pump control over-ride circuit, to over-ride control of a pump in an irrigation controller installation in the event that said valve interface unit transmits data indicating failure of a valve connected to said valve interface unit.

### BRIEF DESCRIPTION OF DRAWINGS

Two preferred embodiments of the invention will now be described in the following description of an expansion system and a splitter system for controlling operation of from two to four electrically operated valves over a single pair of conductors, made with reference to the drawings, in which:

FIG. 1 is a block schematic of the expansion system according to the first embodiment;

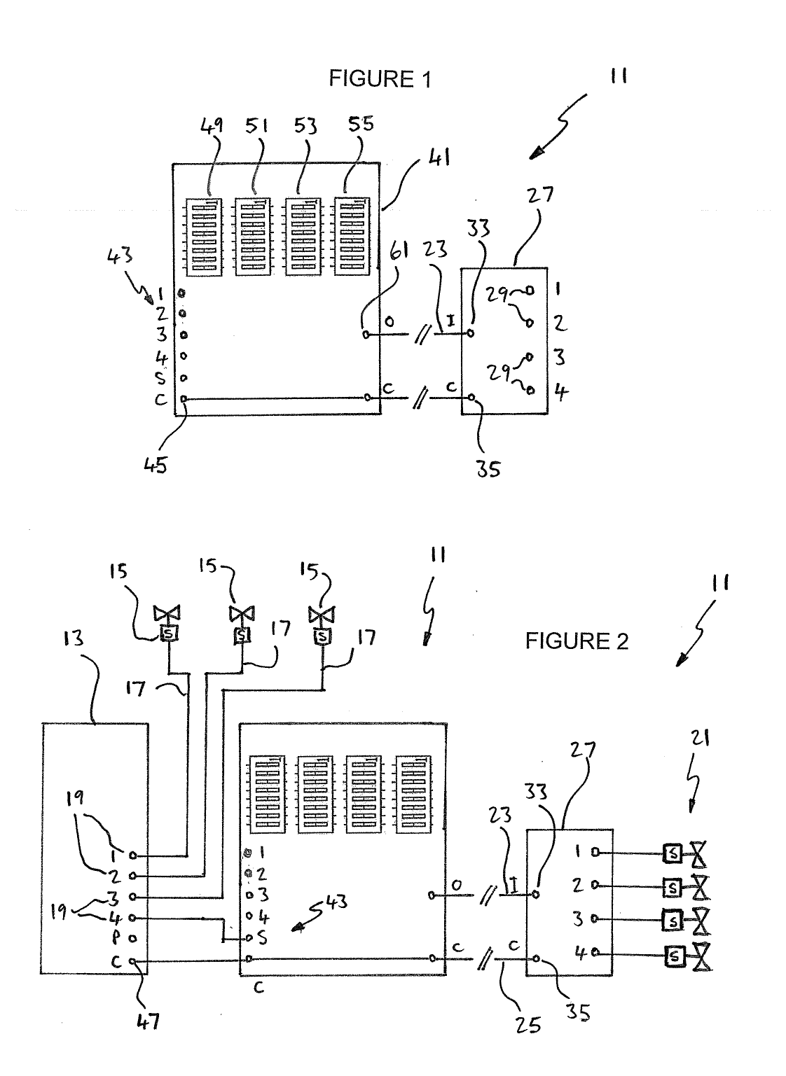

FIG. 2 is a block schematic of the expansion system showing it connected in a first configuration in an irrigation system for lawns and gardens;

FIG. 3 is a block schematic of the expansion system showing it connected in a second configuration in an irrigation system for lawns and gardens;

FIG. 4 is a block schematic of the expansion system showing it connected in a third configuration in an irrigation system for lawns and gardens;

FIGS. 5a and 5b are a circuit diagram of the controller interface portion of the expansion system;

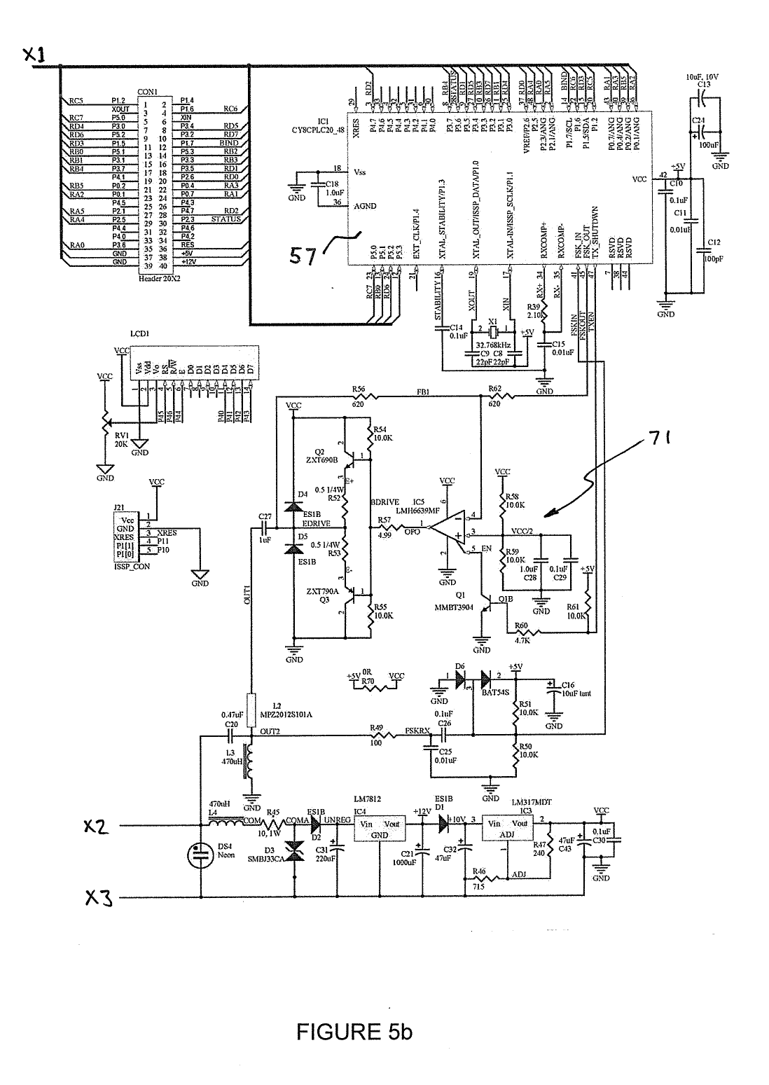

FIGS. 6a and 6b are a circuit diagram of the valve interface portion of the expansion system; and

FIG. 7 is a block schematic of the splitter system according to the second embodiment.

### DESCRIPTION OF EMBODIMENTS

The first embodiment is an interface system in the form of an expansion system indicated generally at 11 for a reticulation/irrigation controller 13 arranged to operate a plurality of electrically operated valves in the form of solenoid valves 15. The solenoid valves 15 are each connected by two wires being an active wire or feed wire 17 to outputs 19 on the irrigation controller 11, and a return or common wire (not shown). In best practice, the common wire is brought back along the same path that the feed wires are laid (though in electrical isolation therefrom), in order to minimise surges induced due to lightning.

The expansion system 11 is provided to operate up to four further solenoid valves 21, but over a single pair of wires being a feed wire 23 and a return or common wire 25. The expansion system 11 has been developed for circumstances where it is desired to increase the number of watering zones in an existing reticulation/garden-watering installation, which requires additional solenoid valves to be installed, and would otherwise require additional wiring to be run from the irrigation controller 13 to the further solenoid valves 21. The running of additional wiring would usually entail the digging of a trench to bury the wires, so the invention obviates the need to do this.

Furthermore, the expansion system provides a solution where it is desired to increase the number of watering zones under two possible scenarios, a first being in a splitter mode or divider mode, which is where the existing irrigation controller does not have sufficient outputs to cater for the increased number of watering zones, and a multiplex mode where the existing irrigation controller does have sufficient watering zones to cater for the increased number of watering zones.

The expansion system 11 consists of two parts—a transmitter, placed near the reticulation/irrigation controller 13 and a receiver which is installed near solenoid valves in the field to which it is to be electrically connected.

The expansion system 11 comprises the receiver part in the form of a valve interface unit 27 having four outputs 29, one to connect to each further solenoid valve 21, and a common connector to connect to the return wire (not shown) from each further solenoid valve 21. The valve interface unit 27 also has an input connector 33 and a common connector 35 to connect to the feed wire 23 and the return wire 25 remotely from the irrigation controller.

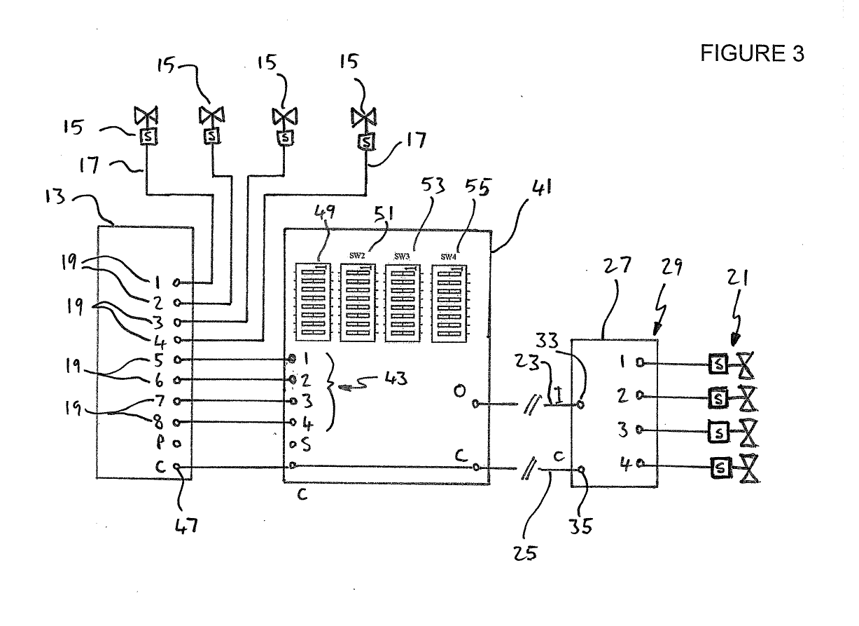

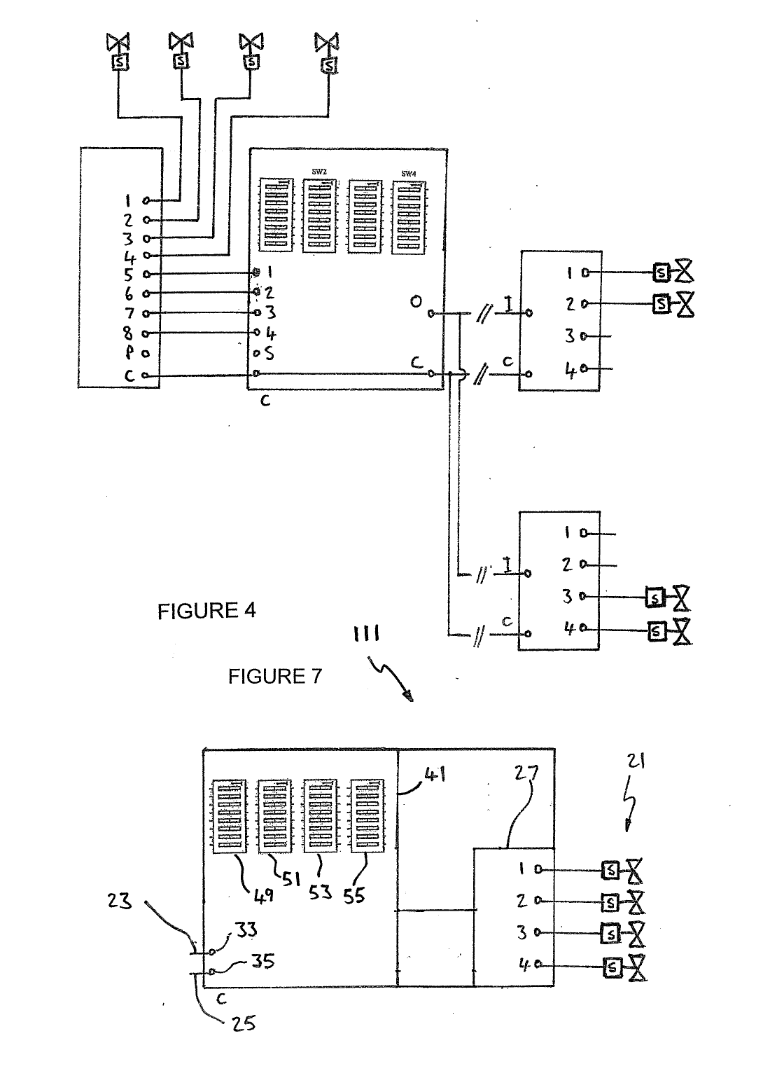

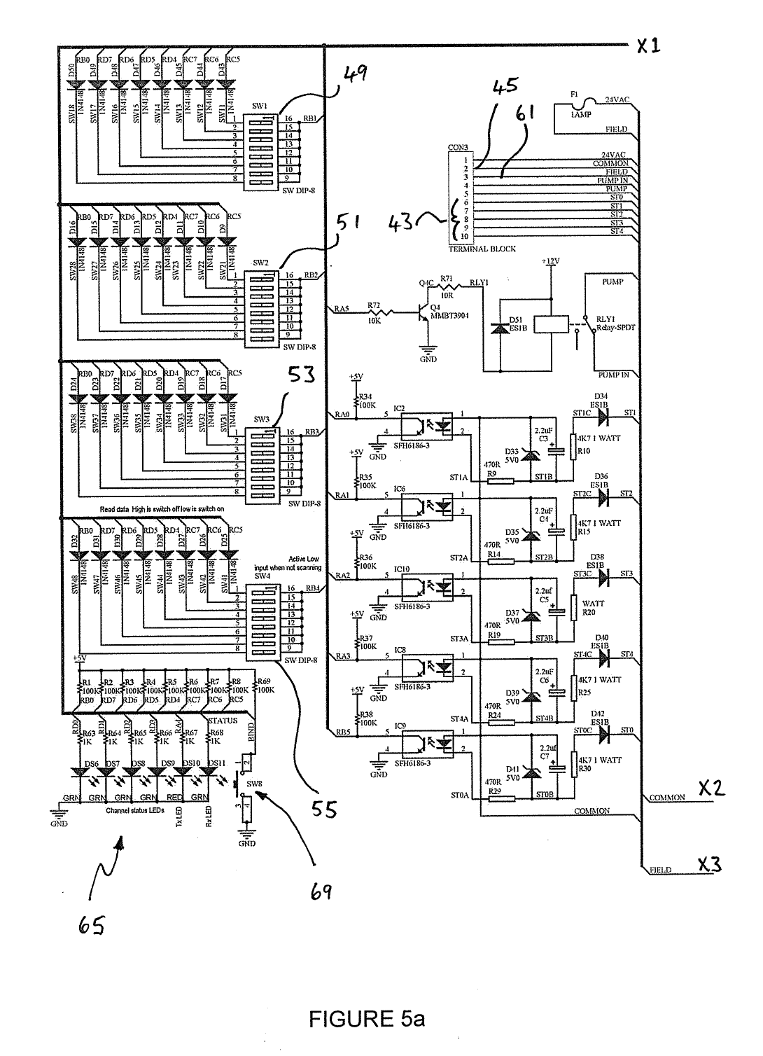

The expansion system 11 also comprises the transmitter part in the form of an irrigation controller interface unit 41 having five inputs 43 labelled “1”, “2”, “3”, “4”, and “S”, which connect to outputs 19 of the irrigation controller 13, along with a common connector 45 which connects to a common connector 47 in the irrigation controller 13. When connecting the irrigation controller interface unit 41 to the irrigation controller 13, either the four inputs 43 labelled “1”, “2”, “3”, “4”, (or however many as are used) connect to separate outputs 19 of the irrigation controller 13 (as shown in FIGS. 3 and 4), or the single input 43 labelled “S” is connected to one only of the outputs 19 of the irrigation controller 13 (as shown in FIG. 2), depending upon which mode the expansion system is operated in.

The irrigation controller interface unit 41 has a user programmable input in the form of four 8-way DIP switches 49, 51, 53, 55, which each set the time set for each individual further solenoid valve 21 at outputs 29 of the valve interface unit 27 labelled “1”, “2”, “3”, and “4”. Each 8-way DIP switch encodes in binary, the run time in minutes for its associated solenoid valve 21, which allows a run time of from 0 to 255 minutes in one minute increments to be set.

In one mode of operation of the expansion system 11, which is the configuration shown in FIG. 2 where the input 43 labelled “S” is connected to output 19 labelled “4”, the DIP switches 49, 51, 53, 55, each set the allocation time for power to each said electrically operated valves 21 which are operated sequentially by the valve interface unit 27, while power is provided to the input and common connectors; that is to say, that switch 49 sets runtime for output 29 labelled “1”, switch 51 sets runtime for output 29 labelled “2”, and so on. In this mode of operation, the sum of the runtimes set by the DIP switches 49, 51, 53, 55 is programmed into the irrigation controller 13 timer as the run time for watering zone 4 (for the output 19 labelled “4”) of the irrigation controller 13.

The irrigation controller interface unit 41 has a controller 57 in the form of a CY8CPCL20_{—}48 programmable logic controller which allocates four unique address codes corresponding to the four solenoid valves 21 connected to the valve interface unit 27. When the valves 21 are to operate, the controller 57 controls delivery of 24 volts AC with an address code modulated thereon corresponding to the valve that is intended to operate, to the output 61 of the irrigation controller interface unit 41. The valve interface unit 27 detects that code and operates the intended valve 21.

For fail safe operation, the valve interface unit 27 may include a circuit to ensure that an output operates if the input is powered. This ensures that if the sum of the runtimes is exceeded due to user error, and the input remains powered, the irrigation controller will not have a pump running against a closed head, and also so that as the controller 63 (a CY8CPLC20) in the valve interface unit 27 initialises on power-up, the irrigation controller will not have a pump running against a closed head. Of course if the time from powering up of the valve interface unit 27 to initialisation of the controller 63 to operation of an output 29 is sufficiently short, the circuit may be dispensed with.

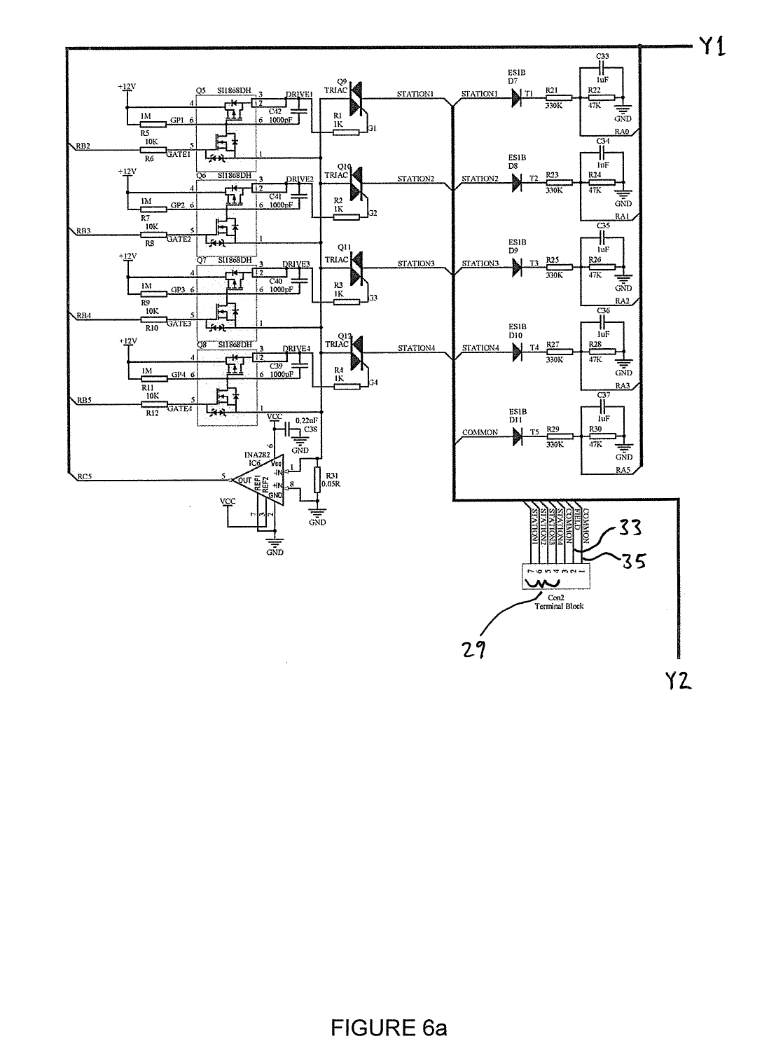

As can be seen in FIG. 6b, the valve interface unit derives its power supply 64 from the power supplied via the input and common connectors.

The above described arrangement, described with reference to the configuration shown in FIG. 2 operates a plurality of valves from a single watering zone output of the irrigation controller, in splitter or divider mode, with the dividing of watering times being determined in the valve interface unit.

Referring to FIG. 3, another configuration is shown. In this arrangement there are four existing solenoid valves 15 connected to outputs 19 labelled “1”, “2”, “3”, and “4” of the irrigation controller, while outputs 19 labelled “5”, “6”, “7”, and “8” are connected to inputs 43 of the irrigation controller interface unit 41 labelled “1”, “2”, “3”, and “4”. The controller in the irrigation controller interface unit 41 detects that any one of these inputs are connected and that input labelled “S” is not connected, and control as set by the of four 8-way DIP switches 49, 51, 53, 55, is disabled. In this arrangement the controller controls delivery of 24 volts AC with an address code modulated thereon corresponding to the particular input 43 labelled “1”, “2”, “3”, or “4” that is powered up by the irrigation controller 13. In other respects the expansion system in this configuration, operates the same as the previous configuration shown in FIG. 2. Thus if the input 43 labelled “1” is on, then the output 29 labelled “1” will be switched on by the valve interface unit 27.

Either above described arrangements of the invention allows multiple watering zones to be controlled via a single pair of wires, with the first arrangement shown in FIG. 2 allowing a single zone of an irrigation controller to be split or expanded into multiple outputs for connection to multiple electrically operated valves (expander mode), and the second arrangement described with respect to FIG. 3 allowing multiple outputs of an irrigation controller to be connected to multiple electrically operated valves over a single pair of wires (splitter mode).

Further technical features of the expansion system 11 of the embodiment will now be described.

The expansion system 11 uses Power Line Control (PLC) techniques to communicate between the irrigation controller interface unit 41 and the valve interface unit 27. Once there is a single or multiple irrigation controller interface units 41 connected to an expansion system 11, then any cable in the system can be used to add further valve interface units 27. The reason for this is that all data is sent on the common cable, and as long as there is a common cable available then data will be present. The primary role for data communication is for the irrigation controller interface unit 41 to send address data for an output 29 (one of outputs labelled “1”, “2”, “3”, or “4”) of the valve interface unit 27 to be actuated. However, in addition to this the controller 63 in the valve interface unit can determine which outputs 29 have a valve 21 connected, and send data pertaining to that to the irrigation controller interface unit 41, to allow the controller 57 in the irrigation controller interface unit 41 to self configure, on initial set-up when being installed. Once configured, should there be a failure due to an electrical fault in the solenoid valves or associated wiring, data pertaining to these errors can be transmitted from the valve interface unit 27 to the irrigation controller interface unit 41 for display on status LEDs 65 in the irrigation controller interface unit 41.

The installation process is as follows: the irrigation controller interface unit 41 is installed adjacent to an existing irrigation controller 13. The irrigation controller interface unit 41 is installed adjacent to an existing irrigation controller 13 irrigation controller interface unit 41 is wired to common connector of the irrigation controller 13. The pump output (typically labelled “P”) of the irrigation controller 13 is connected to “Pump In” pin 3 on CON3 in the irrigation controller interface unit 41, and the “Pump” pin5 on CON 3 is connected to the pump start controller/relay in the irrigation system. The Pump In and Pump connectors are a loop through, normally closed circuit 67, which the controller 57 will open in the event of detecting a fault such as an open circuit output 29 on the valve interface unit 27, to exert over-riding control of the pump in order to prevent system damage that might occur to the pump and pipework, should the pump operate against a closed head.

The 24 VAC terminal pin 1 on CON3 is connected to the 24 VAC lead on the irrigation controller 13 that is not common.

Finally the field wire 23 which will have formerly been used to connect to a solenoid valve in the field, is connected to output connector 61 in the irrigation controller interface unit 41.

The valve interface unit 27 is installed remotely adjacent the group of solenoid valves 21 to which it is to be connected. The remote end of the field wire 23 is connected to input 33, and the other wire at the remote end, which will be the common cable, is connected to terminal 35 in the valve interface unit 27.

The solenoid valves are wired up to outputs 29, with their return wires joined and brought back to the common connector pin 3 on CON2.

If the expansion system 11 is connected in multiplex mode the run times for solenoids 21 are set through the irrigation controller 13, programmed for stations 5 to 8, in the example shown in FIG. 3. In this configuration, the whole system has four stations (watering zones) operating on one pair of cables. The system works the same as if four pairs of cables were installed from the irrigation controller 13, as in a conventional irrigation system.

If the expansion system 11 is connected in splitter mode, the run times for solenoids 21 are set through the DIP switches 49, 51, 53, and 55 in the irrigation controller interface unit 41. These dip switches allow each station to be programmed for from 0 to 255 minutes in 1 minute intervals. Once all stations are allocated a run time in the transmitter the total run time of the four stations is then programmed into the irrigation controller 13 for the station that the wire connecting to the “S” terminal is connected to.

In multiplex mode, each of the four stations is monitored at the valve interface unit 27 end of the system for resistance, overcurrent and over voltage. If a fault occurs on a single station then the LED located in the irrigation controller interface unit 41 for that particular station will flash and the pump will be disconnected until the station from the irrigation controller turns off. By doing this there is no possible way a pump will operate against a closed head caused by a faulty valve or field wire. Further the irrigation controller interface unit 41 can detect if there is a valve interface unit 27 problem (that is different from a particular valve problem). In this case when all four valves are non operational the “power up” LED will flash.

In either multiplex or splitter configuration, if less than four stations are required then it is possible to connect only those that are needed, either two or three valves.

In splitter mode, the single station output of the irrigation controller 13 is converted to a maximum of four separate stations at the valve interface unit 27 end of the system. When the connector 43 input labelled “S” is activated via the irrigation controller 13, the “power up” LED is turned on to indicate that there is an AC signal being received by the irrigation controller interface unit 41. This assists in solving installation and troubleshooting faults between the irrigation controller 13 and the irrigation controller interface unit 41.

The irrigation controller interface unit 41 will only allow run times when a solenoid is detected at the valve interface unit 27 end of the system. If a valve is not connected then the irrigation controller interface unit 41 will not activate this output. In this way it is possible to have two or three solenoid valves connected and no special calibration is required by the user. The system works things out for itself.

In splitter mode, the system has an innovative manual run function. This is required because otherwise the only way operation of all of the valves 21 can be made is by running all connected valves 21 for the full programmed run time. The irrigation controller interface unit 41 has a special software routine that in splitter mode compares the “manual run time” to the programmed run time. If the manual run time is less than the programmed run time, the system interprets this as a manual or test run is being undertaken, and once the system is stopped and started again the irrigation controller interface unit 41 will recommence operation at the next valve 21 in the sequence. In this way it is now possible to run through all the stations 21, connected to the valve interface unit 27 to test their operation, without having to wait for it to run through the programmed times, or without having to reprogram the times for the purposes of the test. This feature also allows the run time of the four stations being split to be programmed on different programmes of the irrigation controller 13. If you set the binary DIP switches 49, 51, 53, 55 to more than the desired run time set for the station in the irrigation controller 13, it is then possible using the DIP switches 49, 51, 53, 55 to programme the same station in the irrigation controller 13 to be run in up to four different programmes of the irrigation controller 13. Because the run time in the programme is less than the run time set on the dip switches the splitter will think this is a manual run time and the next start will automatically move to the next station. The programmes in the irrigation controller must be programmed so that the split station is run four times with at least a minute gap between run times where the system is stopped. Effectively this forces the irrigation controller interface unit 41 to operate the watering system like a cyclomatic valve where the system must be stopped between stations for a change to take place.

Further it is possible to connect more than one valve interface unit 27 to the irrigation controller interface unit 41 and share the stations over different physical locations then at the receiver end only wire those stations that are relevant for the particular area. Such an arrangement is shown in FIG. 4. For example if there is one location in a centre road island and another on a verge and stations 1 and 2 are required on the island and stations 3 and 4 on the verge then only wire to those pertinent stations on each of the two valve interface unit 27 modules and leave the unused stations unconnected. The electronics will work out how many valves are connected ensure those connected are all that will operate.

When using more than one valve interface unit 27 then there will be a need to “bind” the valve interface unit 27 to the irrigation controller interface unit 41. This process of binding is used to allow the irrigation controller interface unit 41 and valve interface unit 27 to only talk to the relevant devices. To bind a device, connect each valve interface unit 27 to the irrigation controller interface unit 41 one at a time and once connected press the bind button 69 in the transmitter unit. When the irrigation controller interface unit 41 and valve interface unit 27 are bound the status LED will flash, do this for as many valve interface units 27 as are required in the system.

This process also allows more than one irrigation controller interface unit 41 to be used on a controller. If multiple irrigation controller interface units 41 and valve interface unit 27 are required on as single irrigation system then only bind those valve interface units 27 that are associated with their respected transmitters, this way every irrigation controller interface unit 41 can remain autonomous.

Adjacent to each splitter DIP switch 49, 51, 53, 55 there is an indicator LED. This LED is only illuminated solid when the valve 21 at the valve interface unit 27 end has been determined as being open. This is done in two ways—there is a resistance checker that makes sure there is a coil connected and if there is then when a valve is instructed to turn on the valve closes and the current to the coil is measured at the receiver end. As long as it is not reading 0 amps (ie the coil is not operating or below the maximum run current of 1 amp) then the LED beside the dip switch is illuminated. If a fault develops on a station from over current or the coil goes open circuit then it will be displayed as a flashing LED and the particular station will be skipped in the splitting sequence with the remaining time being divided to the other stations that are using the splitter.

If a fault condition occurs that does not allow any of the split stations to operate then, the pump bypass relay is activated and the master/pump is disconnected till the run time on the split station from the irrigation controller has expired. Once the run time has expired then the pump is reactivated so that normal watering can occur. If this condition occurs all four LEDs of the irrigation controller interface unit 41 will sequentially flash indicating a major fault has been encountered.

As a consequence of being able to run the expansion system 11 in manual mode, it is also therefore possible to run the expansion system 11 in a fashion that simulates having independent run times. This mode of operation is done as follows. The expansion system 11 switches 49, 51, 53, and 55 are all set to 255 mins. Then the station that has the irrigation controller interface unit 41 attached is set up to run 4 different programs each with its own run time. So long as there is 1 minute between each of the starts for these four different programs then the individual times programed for the station will be determined via the irrigation controller interface unit 41 as the actual run times. This mode of operation requires that the controller has at least 4 programs and preferably it is possible to run any one station in any of these 4 programs with a different run time.

Communications between the irrigation controller interface unit 41 and valve interface unit 27 is based on the use of PLC (Power Line Communication) protocols developed by Cypress Semiconductors. The communication uses the Cypress PLC chip set which has an inbuilt power line modem attached to a Cypress MC8 microprocessor. The operation of the chip set is based on a PHY and protocol stack that interfaces with the 24 VAC line, through an appropriate coupling circuit, which in the embodiment is a capacitor isolated power amplifier 71. The PHY is a generic system supplied by Cypress Semiconductors as part of their PLC application data.

The PLC chip set communicates over the power line by modulating a control signal onto the existing 24 VAC 50/60 hz supply used within the irrigation controller 13. A standard Cenelec modulation technique is used to limit EMF and interference to other power line communication devices. The advantage of doing it this way is that all wiring connected to the irrigation controller 13 and placed on the low voltage side of the control transformer is now able to be used for communication. This approach provides a generic communication path over and above that of the general operation of the irrigation controller 13 through conventional individual wire to each solenoid valve.

The PLC units communicate using a standard packet handler at both the irrigation controller interface unit 41 and valve interface unit 27 ends of the communication chain. The packet also has inbuilt redundancy and CRC checking which allows for bidirectional transfer of data. This has the advantage of allowing a node to respond with critical data about its state of operation its load and fault conditions that might have occurred whist it was operating or changing states.

The Power line packet header details the methods used in communicating data types, direction and quality of data transfer. Although a relatively complex header, its advantage in the embodiment is to allow multiple independent or conjoined receiver and irrigation controller interface units 41 to work in harmony with out collisions or loss of data. So one irrigation controller interface unit 41 can talk with multiple valve interface units 27 or alternatively multiple irrigation controller interface units 41 with valve interface units 27 attached can talk autonomously over the same power line without collision.

In the embodiment, the standard packet header as detailed by Cypress Semiconductors is sent and the packet payload is limited to two bytes. This limitation is put in place only in the transmitter, as it has no need to communicate with any more than 16 bit paths of information at any one time. This limitation in in the transmitter assists with the bandwidth required for transmission and allows a heartbeat tic signal to be sent once per second without any chance of over run or packets loss. Consequentially the receiver is always receiving data in real time without any data latency that might occur due to the low speed and bandwidth limitations of the network.

The system of the embodiment operates by firstly compiling a packet of information at the transmitter end, sending this onto the power line and then receiving and decoding this at the receiver end. At the irrigation controller interface unit 41, the encoding of information is based on the collection of data from five inputs 43 that are wired to the irrigation controller 13 and provide 24 VAC control signals to the irrigation controller interface unit 41. These control signals are isolated with an optocoupler system and then read into the controller 57. The internal algorithm of the controller 57 determines what input is selected and thus what operation needs to be undertaken. It makes the decisions required at the irrigation controller interface unit 41 end and also determines run times delays and fault status, using the four 8-way DIP switches 49, 51, 53, 55 for time and feedback from the PLC receiver for status. Once the irrigation controller interface unit 41 has compiled the data it places it onto the power line using the power line protocol header and handler that was detailed earlier.

The valve interface unit 27 is a relatively simple device that decodes and decompiles the power line information. It then acts upon the basic on/off instructions sent via the transmitter. Once acted upon it sends a confirmation packet back to the irrigation controller interface unit 41, detailing the information it has collected whilst carrying out the required operation. In the embodiment this collected information is generally about the current consumption of the station the resistance of the valve connected and the voltage that the solenoid coils is has applied to it. This information allows the irrigation controller interface unit 41 to determine if the operation has been successful or if a fault condition should be called and if a fault is called to what level of intervention is required by the irrigation controller interface unit 41 to protect the irrigation controller 13 and any other device attached to it from damage or induced stress. This fault protection intervention could be as simple as skipping a station or as drastic as turning off the pump master valve and shutting down the entire unit.

Other than the power line PHY and modem, the valve interface unit 27 also has in its circuit design a driver system to operate one of four triacs that can supply 24 VAC to the external solenoid coils. The valve interface unit 27 has an individual feedback loop on each triac output that reads back the bleed voltage thru a coil when it is in the non-powered state. This process allows an A/D in the controller 63 to determine the line resistance of each of the attached devices. With this information it can be determined when a valve is attached and working, when a valve is faulty or is going faulty, and when more than a single valve is connected to any one station. There is also a simple bi directional current monitoring system using a shunt resistor that reads the ground return current of the attached solenoid coils whilst they are operating. This system, via another A/D, is used to monitor in real time the current consumption, and if required can shut down any single station or the whole valve interface unit 27, before and overload condition can occur, this overload condition is handled at the receiver end for the valves. The reason for this is so that the system is fast enough to be able to shut down before a catastrophic failure can occur. All of this information is also forwarded back to the irrigation controller interface unit 41 so it may act upon it and respond to the events in an orderly fashion.

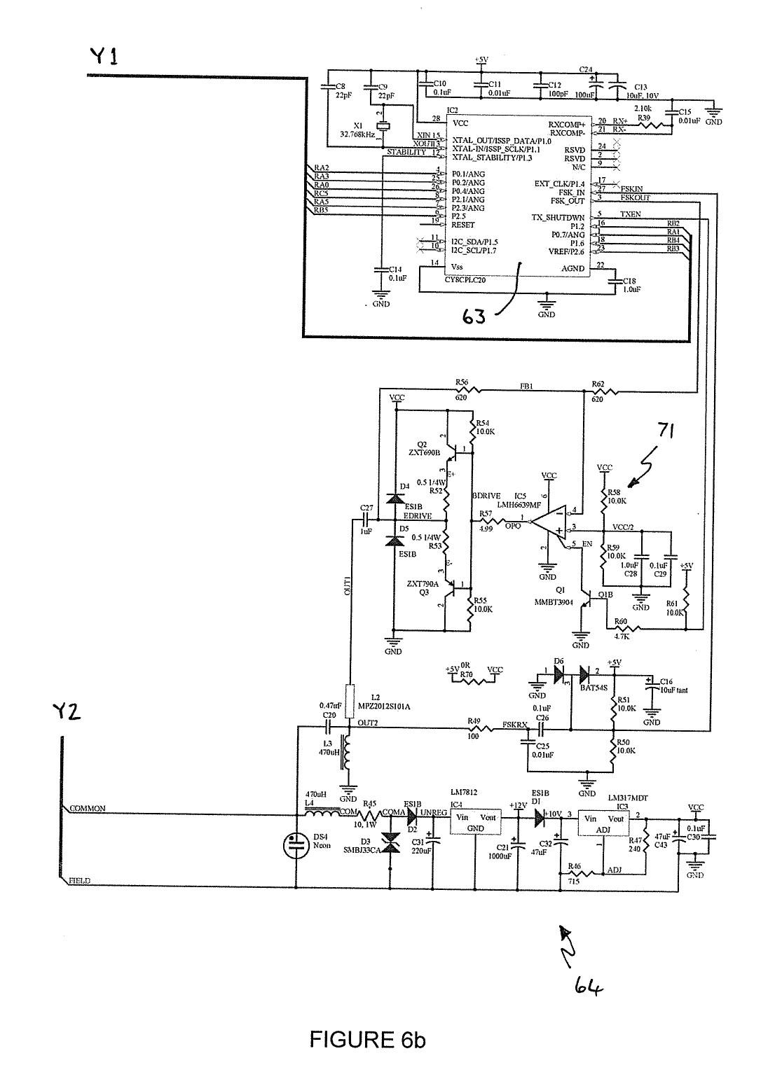

The splitter system 111 according to the second embodiment is shown in FIG. 7. It is fundamentally the same as the expansion system of the first embodiment except that the valve interface unit 27 and the irrigation controller interface unit 41 are co-located within a single unit which is located in the field proximal to the solenoid valves 21. The feed wire 23 and the return wire are brought from the irrigation controller and connected to the input connector 33 and common connector 35 respectively. The times for outputs 29 (1, 2, 3, 4) are set by DIP switches 49, 51, 53, and 55 to add up to the same time as programmed for the output of the irrigation controller to which the feed wire 23 is connected.

It should be appreciated that the scope of the invention is not limited to the particular embodiment described herein.

What is claimed is:

1. An interface system for an irrigation controller arranged to operate a plurality of electrically operated valves over at least two wires being at least one feed and a return, wherein said interface system includes a valve interface unit having at least one output, each output for connection to an electrically operated valve, and a return/ common connection for connection to said electrically operated valves, and an input and common connectors to connect to a feed wire and a return wire remotely from said irrigation controller; said interface system having a user programmable input interfaced with a controller to set the allocation time for power to each of said electrically operated valves sequentially, while power is provided to the input and common connectors.

2. An interface system as claimed in claim 1 wherein, for fail safe operation, said valve interface unit includes a circuit to ensure that an output of said at least one output operates if the input is powered.

3. An interface system as claimed in claim 1 wherein the valve interface unit derives its power supply from the power supplied via the input and common connectors.

4. An interface system as claimed in claim 3 wherein the valve interface unit includes a circuit to supply power to an output of said at least one output while circuitry in said valve interface unit initialises on powering up said input and common connectors.

5. An interface system as claimed in claim 1 wherein the user programmable input comprises a set of switches through which runtime can be entered for each said output to each said electrically operated valve.

6. An interface system as claimed in claim 5 wherein the user programmable input comprises a set of switches through which runtimes can be entered separately for each said output to each said electrically operated valve.

7. An interface system as claimed in claim 6 wherein the user programmable input comprises a set of 8 way dip switches, being one for each said output, each 8 way dip switch being used to set in binary a runtime variation of from 0 to 256 minutes in one minute intervals.

8. An interface system as claimed in claim 1 including an irrigation controller interface unit having a plurality of inputs for connection to irrigation controller watering zone outputs and a return/common connector to connect to the irrigation controller common, and an output being for connection to a feed to connect remotely to the input connector of said valve interface unit, where said irrigation controller interface unit includes and encoder to encode data onto wiring connecting the valve interface unit to identify which irrigation controller interface unit input is actuated, and said valve interface unit includes a decoder to decode said data and provide said data to said controller, and said controller on receiving said data operates to switch on the appropriate output of the valve interface unit corresponding with the input of the irrigation controller interface unit that is actuated.

9. An interface system as claimed in claim 8 wherein the controller includes a switch associated therewith to select the controller between operating valves according to the allocation times or according to the decoded data, the switch being an internal switch that is operated automatically on detection of data.

10. An interface system as claimed in claim 9 wherein the irrigation controller interface unit is arranged to only encode data if more than one input is connected to an irrigation controller output.

11. An interface system as claimed in claim 8 wherein said user programmable input for setting the runtimes and the controller, are located in the irrigation controller interface unit.

12. An interface system as claimed in claim 8 wherein the irrigation controller interface unit includes circuitry to detect how many inputs are connected to an irrigation controller, wherein if more than one input is connected, said user programmable input for setting the runtimes and the controller are disabled by said circuitry, and said encoder encodes data onto wiring connecting said valve interface unit to identify which irrigation controller interface unit input is actuated;
and if only one input is connected, said user programmable input for setting the runtimes and the controller are enabled by said circuitry, and said encoder encodes data onto wiring connecting said valve interface unit to identify which valve is selected to be operated by said controller.

13. An interface system as claimed in claim 8 wherein a single separate input is provided in said irrigation controller interface, where if connected, said user programmable input for setting the runtimes and the controller are enabled by said circuitry, and said encoder encodes data onto wiring connecting said valve interface unit to identify which valve is selected to be operated by said controller.

14. An interface system as claimed in claim 13 wherein if said single separate input is not connected, said user programmable input for setting the runtimes and the controller are disabled by said circuitry, and said encoder encodes data onto wiring connecting said valve interface unit to identify which irrigation controller interface unit input is actuated.

15. An interface system as claimed in claim 8 wherein data communication between said irrigation controller interface unit and said valve interface unit is two way to enable fault data to be transmitted back to said irrigation controller interface unit.

16. An interface system as claimed in claim 15 wherein said irrigation controller interface unit includes a pump control over-ride circuit, to over-ride control of a pump in an irrigation controller installation in the event that said valve interface unit transmits data indicating failure of a valve connected to said valve interface unit.

17. An interface system as claimed in claim 8 wherein, for fail safe operation, said valve interface unit includes a circuit to ensure that an output of said at least one output operates if the input is powered.

18. An interface system as claimed in claim 8 wherein the valve interface unit derives its power supply from the power supplied via the input and common connectors.

19. An interface system as claimed in claim 16 wherein the valve interface unit includes a circuit to supply power to an output of said at least one output while circuitry in said valve interface unit initialises on powering up said input and common connectors.

20. An interface system as claimed in claim 8 wherein the user programmable input comprises a set of switches through which runtime can be entered for each said output to each said electrically operated valve.
